(19) United States
(12) Patent Application Publication
(10) Pub. No.: US 2004/0234729 A1
(43) Pub. Date: Nov. 25, 2004

(54) Composite vehicle part and method of manufacturing a composite vehicle part

(76) Inventors: Frank Niebuhr, Gifhorn (DE); Matthias Ludwig, Vechelde (DE); Sven Hardel, Obernholz/Wettendorf (DE); Joachim Bebenroth-Struss, Isenbuttel (DE); Hans-Joachim Langhoff, Gifhorn (DE); Tobias Niesner, Wolfsburg (DE); Harald Batke, Gerstenbuttel (DE); Soren Beneke, Gifhorn (DE); Marcus Lutz, Gifhorn (DE)

Correspondence Address: CARLSON, GASKEY & OLDS, P.C., 400 WEST MAPLE ROAD, SUITE 350, BIRMINGHAM, MI, 48009, US

(21) Appl. No.: 10/849,618

(22) Filed: May 19, 2004

(30) Foreign Application Priority Data
May 21, 2003 (DE) 103 22 994.9

(51) Int. Cl. B32B 1/04

(52) U.S. Cl. 428/174

(57) ABSTRACT

A composite part, such as a mount-on car body panel, is manufactured as a foil part covered by a protective foil. The foil part and protective foil are both inserted into a foam die. Before the insertion, the protective foil is reworked on an outer side of the protective foil to remove rough areas. The resulting composite part has improved surface characteristics due to the reworking step.

### REFERENCE TO RELATED APPLICATIONS

The present invention claims the benefit of German Patent Application No. 103 22 994.9, filed May 21, 2003.

### TECHNICAL FIELD

The present invention relates to a method for manufacturing a composite part, and specifically a vehicle part that is visible in an installed state, such as a mount-on car body panel. In addition, the present invention relates to a vehicle part that is manufactured using the method according to the present invention.

### BACKGROUND OF THE INVENTION

A mount-on vehicle body panel is a vehicle part attached to a vehicle body that, in a final mounted state, defines an outer skin of the vehicle and that is visible from the outside. Mount-on vehicle body panels of this type should have minimal weight, good strength properties, excellent surface quality (e.g., a class A surface), good thermal properties and good sound insulation properties. They should also be optically adjusted for visual compatibility with any adjacent painted parts so that the vehicle will have a uniform appearance. In particular, a mount-on vehicle body panel can be a roof module, including a roof module having a sliding sunroof unit or a multiple-panel roof. Other application possibilities are hinged parts (e.g., doors and covers), fenders or bumpers.

Manufacturing vehicle body parts, such as roof modules, as composite parts is known in the art. Such vehicle body parts usually have an exterior-facing, painted plastic foil, which in this case is advantageously through-painted and which can also be designated as a foil part. On an interior-facing portion of the vehicle body part, the plastic foil is back-foamed or polyurethane material. A plastic layer is disposed on the rear side of the plastic foil by a separate step where liquid plastic is applied onto the plastic foil by foaming or injection-molding.

In addition, a vehicle interior may also contain component parts that are visible in the installed state and that may themselves be composite parts. These component parts should also have a high surface quality; in particular, e.g., trim applications that are adjusted to the color of the vehicle should have surface qualities comparable to the surface qualities of other visible parts of the vehicle.

In one prior method for manufacturing a composite part, a foil that has yet to be back-foamed (hereinafter termed “foil part”) is delivered to a part manufacturer with a protective foil on its exterior side. Due to the protective foil, the exterior side of the foil part, which will later be visible on the completed composite part, is not damaged during shipment. The component part that will be finished later is also delivered to an automobile manufacturer with the protective foil on it. The protective foil is removed just before assembling the composite part onto the vehicle in order to avoid damage or contamination.

There is a desire for a method of manufacturing a composite part which, with respect to the outer skin of the composite part, satisfies extremely high optical requirements and which nevertheless is relatively simple to manufacture.

### SUMMARY OF THE INVENTION

For this purpose, the method according to one embodiment of the present invention comprises providing a foil part that constitutes a visible outer skin of a composite part. The foil part is furnished on a front side with a removable protective foil. An outer side of the protective foil is reworked to remove any rough areas on the protective foil. The foil part is then placed into a die together with the protective foil, and a plastic layer is applied to a rear side of the foil part via a high-pressure manufacturing process, such as back-foaming or injection-molding.

The reworking step in the inventive method can be an abrasive step to achieve a smooth outer surface. More specifically, the protective foil may be polished on the outer side before the foil part is back-foamed or injection-molded on its rear side. This means that when a unit made of the foil part and the protective foil is placed into a foam or injection die, it is smoother and has fewer or no rough areas on the outer side of the protective foil as compared with a non-reworked protective foil. Therefore, the inventive method prevents any rough areas from making impressions in the foil part during the subsequent high-pressure foaming or injection-molding steps. The composite part therefore will have a surface quality that is even better than the surface quality of painted steel parts.

In addition, the present invention relates to a vehicle part that is manufactured in accordance with the above-mentioned method and to an intermediate product made of a foil part having a plastic layer applied by a high-pressure process, such as back-foaming or injection-molding, on its rear side and a protective foil that completely covers the entire surface of the front side foil part and is also processed on its outer side through polishing.

### BRIEF DESCRIPTION OF THE DRAWINGS

Further features and advantages of the present invention will become apparent from the following description and from the following drawings. In the drawings:

FIG. 1 depicts a schematic perspective view of a vehicle roof having a mount-on car body panel manufactured according to one embodiment of the present invention;

FIG. 2 depicts an enlarged cutaway view of a foil part provided with a protective foil in cross-section;

FIG. 3 depicts a cross-sectional view of a deep-drawn foil part together with a protective foil;

FIG. 4 depicts a cross-sectional view of an intermediate product according to one embodiment of the present invention having a protective foil that is processed on its outer side;

FIG. 5 depicts a schematic cutaway view of a foam or injection die having an inserted foil part after a foaming or injection process; and

FIG. 6 depicts a cutaway view of a finished composite part.

### DETAILED DESCRIPTION OF THE PREFERRED EMBODIMENT

Generally, the present invention is directed to providing a foil part that constitutes a visible outer skin of a composite part. The foil part is furnished on its front side with a removable protective foil. The protective foil is reworked on an outer side of the protective foil to remove any rough areas on the foil part. The reworked foil part is then placed in a die together with the protective foil. A plastic layer is then applied on a rear side of the foil part via a high-pressure manufacturing process, such as back-foaming or injection-molding.

In a method according to one embodiment of the present invention, the protective foil remains on the foil part throughout the entire method, even in the foam or injection die where enormously high pressures are exerted. Because the foil part advantageously has a material thickness between 0.5 and 1 mm, the extremely high pressures encountered during the plastic layer application process could easily damage the front side of the foil part and therefore the outer skin of the final composite part. Providing the protective foil on the foil part, however, does not completely prevent surface damage of the foil part because any contaminants (e.g., dirt contamination) in the protective foil, even the finest contaminants, will create raised or thickened locations in the protective foil.

When the foil part is placed in a foam or injection die and subjected to high pressure, these contaminants are pressed into the outer skin of the foil part and generate small cavities, which reduce the quality of the outer skin's surface. When the foil part is evaluated according to automobile manufacturer requirements, these cavities can result in a high degree of surface spoilage of the nearly-finished composite part. These cavities cannot be touched up or repaired. Although protective foils are constantly being improved, it has nevertheless not been possible to obtain protective foils that are completely free of contaminants or dirt contamination.

To avoid the above-mentioned disadvantage, the present invention includes a reworking step that reworks the protective foil on its outer side via an abrasive process to achieve a smooth outer surface. More specifically, the protective foil is polished on its outer side before the foil part is back-foamed or injection-molded on its rear side. The reworking step causes the unit made up of the foil part and the protective foil, which is placed into the foam or injection die, to be smoother and have fewer or no rough areas on the outer side of the protective foil as compared to the non-reworked protective foil. Therefore, the reworking step eliminates any rough areas that would otherwise make impressions in the foil part during the subsequent high-pressure foaming or injection molding process. The resulting composite part has a surface quality that is even better than the surface quality of painted steel parts.

The foil part is advantageously reshaped in a permanent manner without removing the protective foil before the protective foil is reworked.

In one embodiment, the foil part specifically is made of thermoplastic material and is plastically reshaped in response to heat, for example, in a deep-draw process.

Advantageously, the foil part is reshaped in the form of a trough, and a liquid plastic is introduced on the rear side of the foil part into the trough during a high-pressure plastic layer application process, e.g., foam or injection-molding process.

To increase the stability of the composite part, the plastic layer applied in the high-pressure manufacturing process may be provided with fibers, such as glass fibers.

As noted above, the method according to one embodiment of the present invention is specifically provided for manufacturing a mount-on car body panel, in other words, a motor vehicle structural or cladding part.

In addition, the present invention generally relates to a vehicle part that is manufactured in accordance with the above-mentioned method and to an intermediate product made of a foil part that has a plastic layer applied to its rear side via a high-pressure manufacturing process (e.g., back-foaming or injection-molding) and a protective foil. The protective foil completely covers the entire surface of a front side of the foil part and is reworked on its front side through polishing or a similar abrasive process.

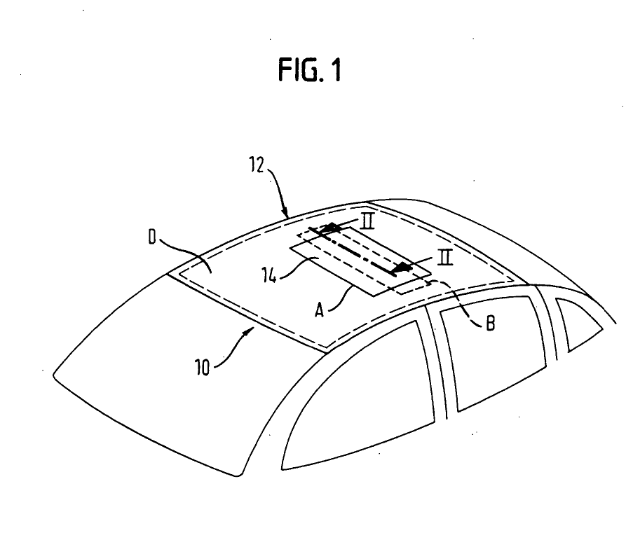

Referring to the figures, FIG. 1 depicts a vehicle roof 10 whose outer skin is defined at least in segments by a mount-on car body panel in the form of a composite part 12. The mount-on car body panel can be, for example, an entire roof module D, a cover A, or a multiple panel unit B for closing a roof opening. Other possible applications for the mount-on car body part are doors, hinged parts, vehicle bumpers, and segments of an outer skin of any car body part as well as parts of the interior covering.

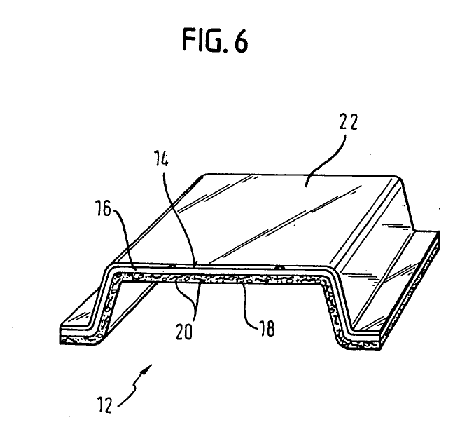

As shown in FIG. 6, the composite part 12 is made up of a plurality of plastic layers that are bonded to each other. An outer skin that is visible in the installed state defines an exterior side 14 of the composite part 12. In one embodiment, a foil part 16 in the composite part 12 is made up of a plastic foil that has a maximum thickness of, for example, 1.5 mm. The foil part 16 may be a two-layer co-extruded foil. An outer layer of the foil part 16 may be a hard covering layer, advantageously made of polymethyl methacrylate (PMMA), which on the interior side is bonded to a through-painted carrier layer, advantageously made of a mixture of polycarbonate (PC) and acrylonitrile-styrene-acrylic acid ester-copolymer (ASA). In one embodiment, the covering layer of the foil part 16 is roughly only 0.4 mm thick and can be transparent and/or through-painted. For simplicity, the two layers of the foil part 16 are not depicted separately in FIG. 6.

Due to the through-painting of the layers, an exterior-side paint covering can be omitted from the foil part 16. On a rear side, the foil part 16 has a plastic layer 18 applied by any high-pressure manufacturing process, such as back-foaming or injection-molding. In one embodiment, the plastic layer 18 is made of a polyurethane material into which glass fibers 20 are introduced in a randomly distributed fashion during the foaming or injection process. This fiber introduction method is also called a Long Fiber Injection (LFI) method.

Between the foil part 16 and the plastic layer 18, it is also possible to provide an additional separating layer or the like (not shown), such as an open-cell foam layer, if appropriate. The additional separating layer may be included to prevent glass fibers 20 from leaving impressions on the outer skin defining the exterior side 14 of the foil part 16.

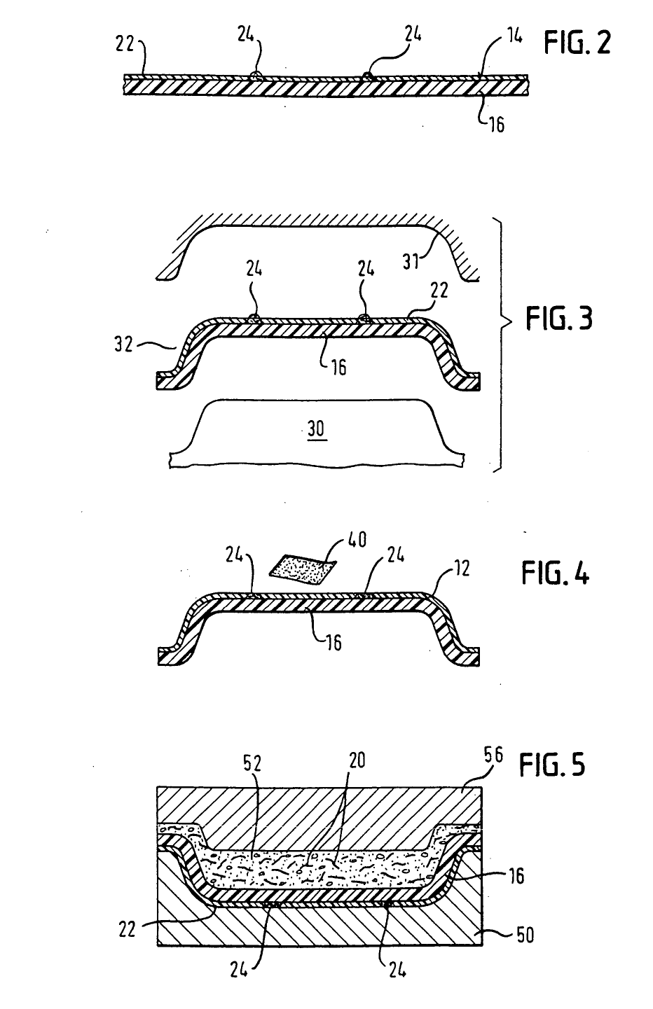

FIGS. 2 through 6 illustrate a method for manufacturing the composite part 12 according to one embodiment of the invention.

First, the foil part 16 is prepared (FIG. 2) to have a thin protective foil 22, such as one made of plastic, that completely covers the exterior side 14 of the foil part 16. The unit formed by the foil part 16 and the protective foil 22 together is supplied to the manufacturer in finished form, for example, in large rolls or thin plates. The protective foil 22 almost always has contaminants that form a plurality of rough areas 24, which represent elevations and are also termed dirt contamination. The protective foil 22 is typically applied in the process of extruding the foil part 16.

In the next step (FIG. 3), the foil part 16 is deep drawn. The foil part 16 is secured on its edge sides 32. A stamp 30 and simultaneous application of heat plastically presses the foil part 16 into a die 31 to permanently deform the foil part 16. The foil part 16 has a trough-shaped appearance after the deep drawing process in this example. Further, the edge 32 advantageously runs in a closed circle.

In the next step of the method (FIG. 4), the protective foil 22 is reworked on its outer side using an abrasive, such as fine sandpaper 40, via any appropriate process (e.g., by hand) so that the rough areas 24 no longer protrude from the protective foil 22. The rough areas 24 are therefore removed through this abrasive process.

The intermediate product that is thus formed in this manner is then placed into a lower part 50 of a foam die (FIG. 5) so that the protective foil 22 rests on the interior surface of the lower part 50. A liquid plastic 52, such as a liquid polyurethane material, is applied to the foil part 16 on its rear side as a foam material. Glass fibers 20 may be injected into the foam material. Then, an upper part 56 of the foam die is lowered onto the liquid plastic 52 to form a hollow space between the foil part 16 and the upper part 56 of the die, where the hollow space is filled with the liquid plastic 52. The die is advantageously heated, causing the liquid plastic 52 to foam out, bonding to the foil part 16 in the process.

As an alternative to the back-foaming process described above, the liquid plastic 52 can be injection-molded into the space between the foil part 16 and the upper part 56 of the die to form the plastic layer 18 on the rear side of the foil part 16.

The newly-formed composite part 12 is then removed from the die and is delivered to the automobile manufacturer together with its protective foil 22 covering. The protective foil 22 is removed before installation of the composite part 12 to the vehicle.

Due to the reworking process on the outer surface of the protective foil 22, the manufactured composite part 12 has no surface defects and does not have to be repainted. The reworking method itself can be any surface conditioning process, such as polishing. The exterior side of the protective foil 22 can be finished completely or only at the locations having rough areas 24. This finishing could also be carried out using a tool, for example, a robot-guided tool.

As an alternative embodiment, the protective foil 22 may be reworked before the foil part 16 is plastically reshaped as shown in FIG. 3, allowing the step shown in FIG. 4 to be eliminated.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A method for manufacturing a composite part having an outer skin that is visible when the composite part is installed in a vehicle, comprising:
providing a foil part having the outer skin, the foil part having a removable protective foil disposed on a front side of the outer skin, the protective foil having an outer side;
reworking the protective foil to smooth a surface of the outer side of the protective foil;
placing the foil part together with the protective foil in a die; and
applying a plastic layer via a high-pressure process on a rear side of the outer skin.

2. The method as recited in claim 1, wherein the high-pressure process used in the step of applying the plastic layer is selected from the group consisting of back-foaming and injection-molding.

3. The method as recited in claim 1, further comprising reshaping the foil part after the reworking step.

4. The method as recited in claim 1, further comprising reshaping the foil part after the providing step and before the reworking step.

5. The method as recited in claim 1, further comprising plastically reshaping the foil part under an influence of heat.

6. The method as recited in claim 1, further comprising reshaping the foil part to obtain a trough-like shape.

7. The method as recited in claim 1, wherein the foil part comprises a thermoplastic material.

8. The method as recited in claim 1, wherein the foil part includes a two-layer co-extruded foil.

9. The method as recited in claim 1, further comprising introducing a plurality of reinforcing fibers into the plastic layer.

10. The method as recited in claim 1, wherein the high-pressure process used in the step of applying the plastic layer is selected from the group consisting of back-foaming and injection-molding, and wherein the method includes a step of introducing a plurality of glass fibers into the plastic layer.

11. The method as recited in claim 10, wherein the step of introducing the plurality of glass fibers into the liquid foam material is conducted via a Long Fiber Injection method.

12. The method as recited in claim 1, wherein the step of reworking the protective foil comprises polishing the protective foil on the outer side.

13. The method as recited in claim 1, wherein the composite part is a mount-on vehicle body panel.

14. A mount-on vehicle body panel, comprising:
a foil part having an outer skin that is visible when the mount-on vehicle body panel is installed and a removable protective foil disposed on a front side of the outer skin, the protective foil having an outer side wherein the protective foil has been reworked to smooth a surface of the outer side of the protective foil, and wherein the foil part together with the protective foil was placed in a die; and
a plastic layer that was applied via a high-pressure process in the die on a rear side of the outer skin.

15. The mount-on vehicle body panel as recited in claim 14, wherein the foil part was reshaped after the protective foil was reworked.

16. The mount-on vehicle body panel as recited in claim 14, wherein the foil part has a trough-like shape.

17. The mount-on vehicle body panel as recited in claim 14, wherein the foil part comprises a thermoplastic material.

18. The mount-on vehicle body panel as recited in claim 14, wherein the foil part includes a two-layer co-extruded foil.

19. The mount-on vehicle body panel as recited in claim 14, further comprising a plurality of reinforcing fibers in the plastic layer.

20. The mount-on vehicle body panel as recited in claim 19, wherein the plurality of reinforcing fibers are glass fibers.

21. The mount-on vehicle body panel as recited in claim 14, wherein the protective foil has an outer side, and wherein the protective foil was reworked by polishing the protective foil on the outer side.

22. An intermediate product for manufacturing a composite part, in particular, a vehicle part, comprising:
a reshaped foil part having a front side; and
a protective foil applied on the front side of the reshaped foil part and covering the front side of the reshaped foil part, wherein the protective foil has an outer side that has been reworked to remove rough areas on the front side of the reshaped foil part.

23. The intermediate product as recited in claim 22, wherein the outer side of the protective foil was reworked via polishing.
